(19) United States
(12) Patent Application Publication
(10) Pub. No.: US 2021/0065549 A1
(43) Pub. Date: Mar. 4, 2021

(54) PARKING/STOPPING POSITION GUIDANCE SYSTEM AND DATABASE GENERATION DEVICE

(71) Applicant: DENSO CORPORATION, Kariya-city (JP)

(72) Inventor: Yousuke KIMURA, Kariya-city (JP)

(21) Appl. No.: 17/009,811

(22) Filed: Sep. 2, 2020

(30) Foreign Application Priority Data
Sep. 4, 2019 (JP) 2019-161206

(51) Int. Cl. G08G 1/14; G08G 1/01; G01C 21/36

(52) U.S. Cl. CPC G08G 1/141; G01C 21/3626; G08G 1/0133

(57) ABSTRACT

A target position guidance system includes: a target position database in which position information indicating respective positions of target positions where a vehicle can be parked or stopped is stored; a destination input unit; and a user identification unit. When a target position recommendation unit extracts from the target position database target positions of the vehicle near a destination based on the destination input from the destination input unit, and selects one that matches attribute or preference of a user identified by a user identification unit, the selected target position is recommended to the user as the destination of a travel of the vehicle.

### CROSS REFERENCE TO RELATED APPLICATION

The present application is based on and claims the benefit of priority of Japanese Patent Application No. 2019-161206, filed on Sep. 4, 2019, the disclosure of which is incorporated herein by reference.

### TECHNICAL FIELD

The present disclosure generally relates to (i) a target position guidance system that guides a position suitable for parking or stopping a vehicle near a destination, and (ii) a database generation device that generates a target position database used in such guidance system.

### BACKGROUND INFORMATION

When a vehicle is parked or stopped, a system may send a position of the vehicle and information indicating whether the vehicle is parked or stopped to a center device (e.g., a device in an information center).

A center device may classify whether the vehicle position is a position where the vehicle can be stopped or a position where the vehicle can be parked, based on the information obtained from the vehicle, and may generate a database of parking and stopping positions.

### SUMMARY

It is an object of the present disclosure to provide a system which guides a user of a vehicle to a “best” suited parking/stopping position (i.e., target position) suitable for parking or for stopping the vehicle near a destination.

In this specification, the term “stopping” includes the vehicle reducing to zero velocity for a short time, such as a bus stopping at a bus stop to permit paying passengers to enter or exit. The term “parking” includes the vehicle reducing to a zero velocity in a location for a long time, for example in a shopping mall parking lot such that a driver may leave the vehicle and go shopping. Other factors may also be considered, such as whether an engine is turned off. Further, the term “parking/stopping position” may be called a “target position” for brevity.

### BRIEF DESCRIPTION OF THE DRAWINGS

Objects, features, and advantages of the present disclosure will become more apparent from the following detailed description made with reference to the accompanying drawings, in which:

FIG. 1 is a diagram of an overall configuration of a target position guidance system according to an embodiment;

FIG. 2 is a block diagram of a configuration of a vehicle-side information terminal and a configuration of a server that form the target position guidance system;

FIG. 3 is a diagram of a data structure of a target position database;

FIG. 4 is a diagram of a data structure of a user information database;

FIG. 5 is a flowchart of a control process performed in the information terminal and the server;

FIG. 6 is a diagram of an example of an operation of selecting a target position according to a user preference;

FIG. 7 is a diagram of an example of an operation of selecting a target position according to road conditions (and traffic situation) around a destination;

FIG. 8 is a diagram of another example of an operation of selecting a target position according to a road condition around a destination;

FIG. 9 is a diagram of target position data entry newly registered to the target position database;

FIG. 10 is a flowchart of a partial modification of the control process in which the information of the user and the vehicle is input by operating the information terminal;

FIG. 11 is a flowchart of a partial modification of the control process in which a user and a vehicle are determined by an input from a sensor unit;

FIG. 12 is a flowchart of a partial modification of the control process for re-recommending a target position when a vehicle cannot be parked or stopped at a recommended target; and

FIG. 13 is a flowchart of a partial modification of the control process that allows the target positions to be registered to the target position database with restrictions.

### DETAILED DESCRIPTION

Embodiments of the present disclosure are described below with reference to the drawings.

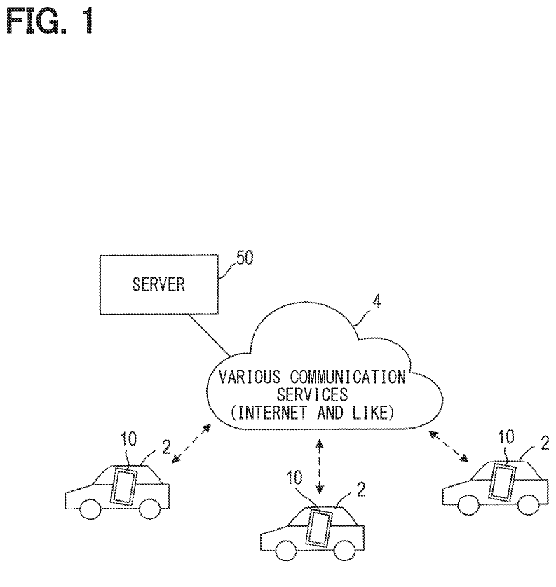

### Outline of System, FIG. 1

As shown in FIG. 1, the target position guidance system according to the present embodiment includes a plurality of information terminals 10 respectively provided in a plurality of vehicles 2 and a server 50 capable of performing two-way communications with the information terminals 10.

The information terminal 10 is provided as an in-vehicle device such as a navigation device mounted on the vehicle 2 or a mobile terminal carried by an occupant of the vehicle 2, which is connectable to the server 50 via a communication service 4 for wireless communication. Note that examples of the mobile terminal may include a smartphone, a tablet terminal, a laptop computer, and the like.

Then, the information terminal 10 transmits or sends a destination to the server 50 via the communication service 4 when the destination is designated by a user (such as a driver or a passenger) of the vehicle 2. On the other hand, when the destination is transmitted from the information terminal 10, the server 50 transmits, in response, to the information terminal 10 a target position suitable for parking or stopping the vehicle 2 near the destination.

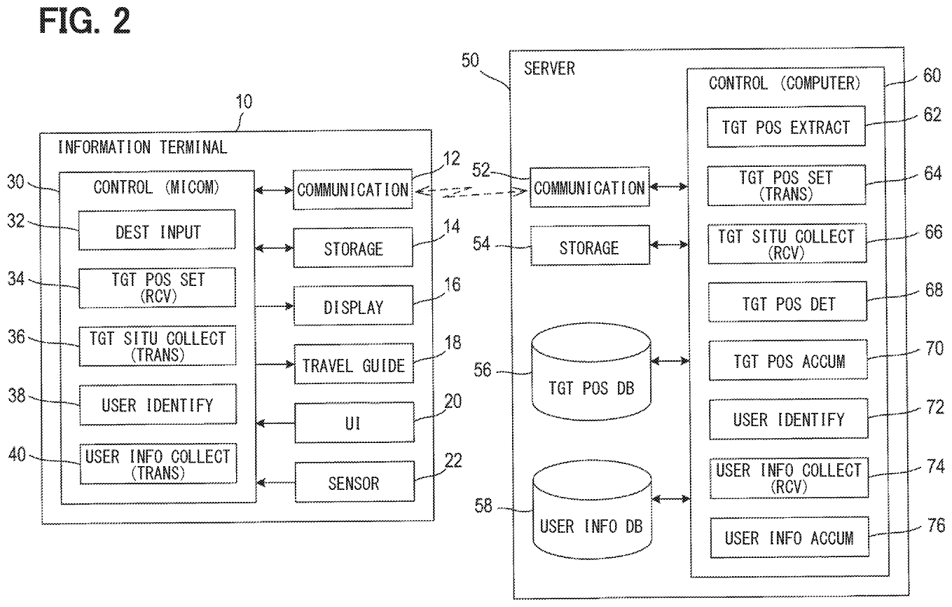

That is, as shown in FIG. 2, the server 50 includes a target position database (hereinafter, target position DB) 56 in which target positions of a vehicle are stored, and a user information database (hereinafter, user information DB) 58 in which user-specific information (i.e., user information specific to each of the users) is stored for each user.

When a destination is received from the information terminal 10, the target position DB 56 is searched to detect a target position suitable for the user to park or stop the vehicle 2 near the destination, and the server 50 recommends the detected position to the information terminal 10.

Then, the information terminal 10 sets a destination of a travel of the vehicle 2 based on recommendation of target position(s) by the server 50, and guides or navigates the vehicle 2 to the set destination.

### Configuration of Information Terminal, FIG. 2

As shown in FIG. 2, the information terminal 10 includes a communication unit 12, a storage unit 14, a display unit 16, a travel guide unit 18, a user interface (UI) unit 20, a sensor unit 22, and a control unit 30.

Here, the communication unit 12 performs bi-directional communications with the server 50 via the communication service 4 by performing wireless communication with the communication service 4, and is configured by or implemented as a predetermined communication circuit.

Then, the communication unit 12 communicates with the server 50 various kinds of information described above such as the destination and the target position, the situation when the vehicle 2 is parked or stopped, and user information.

Further, the storage unit 14 is for temporarily storing information transmitted to and received from the server 50 and information necessary for travel guidance of the vehicle 2, and is provided as a non-volatile memory capable of writing and reading data.

The display unit 16 is for displaying information to the user, and is configured as a display device, an LED, or the like which displays a two-dimensional image.

In addition, the travel guide unit 18 displays an image for travel guidance on the display unit 16 or on a display screen of a navigation device mounted on the vehicle 2, or outputs a guidance voice from a speaker, for a navigation to reach a target position.

In case that the vehicle 2 is an automatic driving vehicle, the travel guide unit 18 may be configured to integrally control a control device of a drive system, a control device of a braking system, and a control device of a steering system in the vehicle 2 so that the vehicle 2 automatically travels to a target position which is set as a destination.

Next, the UI unit 20 is a user interface that includes a touch panel and/or operation buttons for a user to input an operation, and that receives an operation input from the user. The sensor unit 22 is for obtaining detection signals from various sensors that detect a travel state of the vehicle, such as a vehicle speed sensor and a steering angle sensor mounted on the vehicle 2, and is composed of an input circuit for inputting various detection signals.

In addition, the sensor unit 22 is configured to be able to acquire a detection signal including an image from sensors such as an in-vehicle camera, a seating sensor, a door sensor, and a GPS receiver that detect the situation inside or around the vehicle 2 or the vehicle position the vehicle.

Next, the control unit 30 is configured by a microcomputer including a CPU, a ROM, a RAM, etc., and includes functions as a destination input unit 32, a target position setting unit 34, a target situation collection unit 36, a user identification unit 38 and a user information collection unit 40.

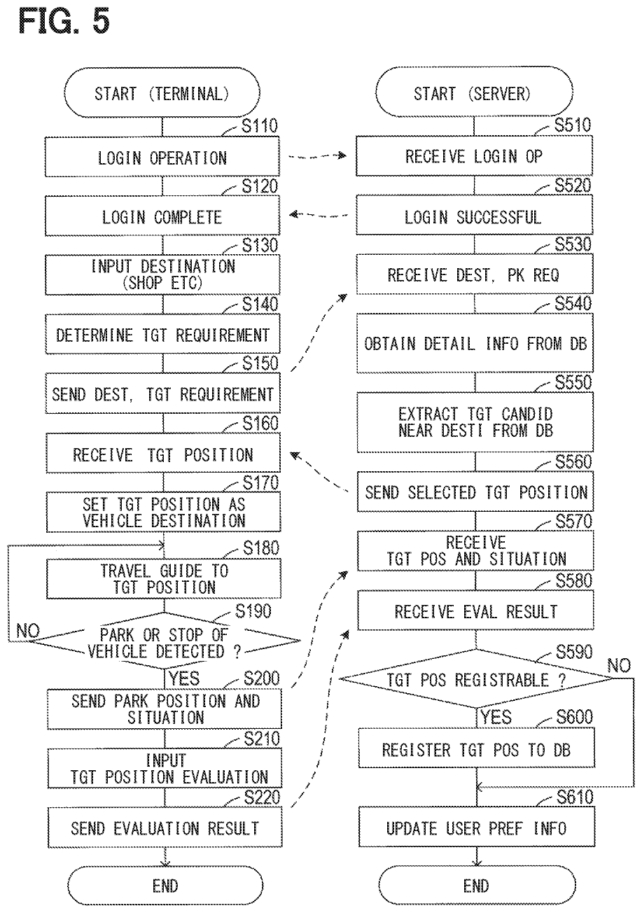

That is, in the control unit 30, the CPU realizes each of those functions by performing the control processing shown on the left side of FIG. 5 according to the program(s) stored in the ROM or in the storage unit 14.

Here, the destination input unit 32 has a function of receiving a destination input by the user via the UI unit 20, that is, a place where the user wants to go, and transmitting the destination to the server 50 via the communication unit 12. The destination input unit 32 may be configured to acquire a destination set in another information terminal from such information terminal.

In addition, the target position setting unit 34 has a function, which receives the target position recommended as a suitable position for parking or stopping the vehicle 2 from the server 50 via the communication unit 12, and sets the received target position as a target destination when the travel guidance of the vehicle 2 is performed.

Next, the target vehicle situation collection unit 36 has a function, which collects a present position, a vehicle state, a situation of vehicle surroundings, etc. regarding the vehicle 2 via the sensor unit 22, and transmits the collected information to the server 50 via the communication unit 12.

Further, the user identification unit 38 identifies a user based on, for example, a direct input from the UI unit 20, an input from the sensor unit 22, the information stored in the storage unit 14, and the like to determine whether the user is a driver or not, that is, it is determined whether the user is a driver and he/she needs to park the vehicle.

Further, the user information collection unit 40 has a function of collecting the user information from which user attributes and user preferences are recognizable, and transmitting the user information to the server 50 via the communication unit 12. The user information collection unit 40 obtains or acquires the user information from a direct input from the UI unit 20, an input from the sensor unit 22, information stored in the storage unit 14, etc., and may also obtain the user information from registration information to Web pages, to other applications and the like. (Configuration of the server, FIG. 2)

On the other hand, the server 50 includes a communication unit 52, a storage unit 54, and a control unit 60 in addition to the target position DB 56 and the user information DB 58 described above.

The communication unit 52 performs bidirectional communication with the information terminal 10 on the vehicle 2 side via the communication service 4, and is configured by a predetermined communication circuit. The communication unit 52 transmits and/or receives various kinds of information such as the destination, the target position, the situation when the vehicle is parked or stopped, and user information to and/or from the information terminal 10 on the vehicle 2 side.

Further, the storage unit 54 temporarily stores the information transmitted to and received from the information terminal 10 and the information read from the target position DB 56 or the user information DB 58, and is provided as the above-mentioned nonvolatile memory, hard disk drive (HDD), solid state drive (SSD), or the like. Note that HDD represents a hard disk drive, and SSD represents a solid state drive.

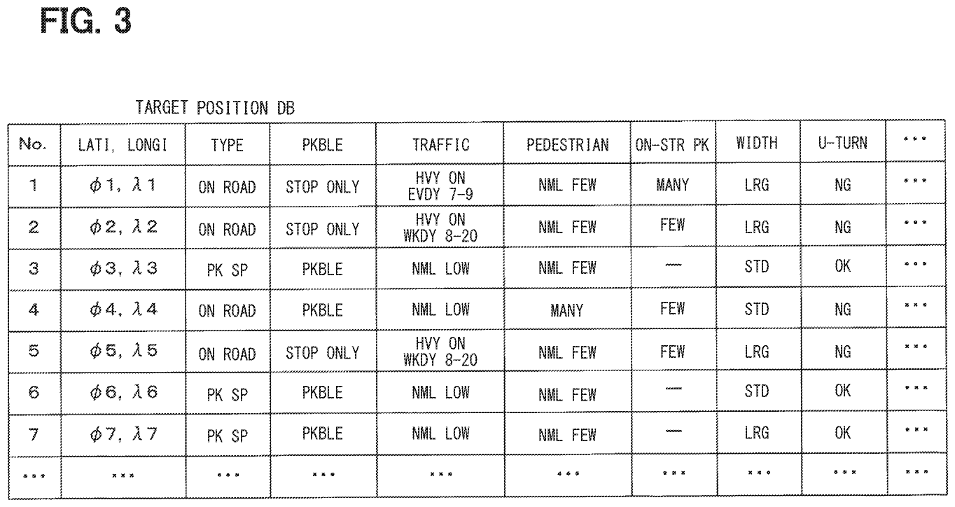

Next, as shown in FIG. 3, the target position DB 56 is provided as a storage medium storing information unique to each of the target positions where the vehicle 2 can be parked or stopped, including position information each represented by latitude (φ) and longitude (λ) and having a registration number assigned thereto.

As information unique to each of the target positions, in addition to the position information described above, type information indicating whether the target position is a position on a road or a position in a parking space, identification information indicating whether the target position allows parking of the vehicle (parkable, hereafter) or allows only stopping of the vehicle (stoppable, hereafter), and road information indicating road conditions around the target position are included. Thus, a user may stop (or park) at a parkable position, but a user may NOT park at a stoppable position.

Further, as the road information, information about traffic volume of vehicles (i.e., number of vehicles therearound), information about pedestrian volume (i.e., number of pedestrians therearound), information about on-street parking volume (i.e., number of parked vehicles on road along sidewalks), information about road width, and regulations information, regarding the road having the target position or the road(s) adjacent thereto. Note that the regulations information includes regulations on vehicle's travel and vehicle's target, such as “no parking,” “do not enter during specific hours” and the like.

Therefore, when the target position near the destination is searched from the target position DB 56, based on the road information described above, it is determined whether the vehicle 2 currently driven by the user or on which the user is currently boarding is parkable or stoppable at a searched target position near the destination.

Further, as shown in FIG. 3, the information about the traffic volume and about the pedestrian volume include registration of time zone when traffic/pedestrian volume is higher/heavier than normal. Therefore, during such time zone, the search for the target position of the vehicle 2 may exclude high traffic/pedestrian volume position from selection.

Further, the information about the width of the road includes information indicating whether the vehicle 2 can turn around (i.e., U-turn) at or around the target position of the road, in addition to information indicating whether the relevant position of the road allows large vehicles or allows only standard/passenger vehicles. Therefore, based on the type of the vehicle 2, the travel direction after the vehicle is parked, and the like, it is possible to determine whether or not the searched target position is a target position suitable for parking or stopping the vehicle 2.

Although not shown in FIG. 3, the target position DB 56 may have, as the position information of the target position registered therein, coordinates on map data different from latitude φ/longitude λ, an address, a name, an intersection name, etc. of the target position.

Further, in the target position DB 56, other information may also be registered as related information of the target position, such as time when the vehicle 2 was parked/stopped, time when the vehicle 2 was started, or originally-set destination set by the user before the vehicle 2 was parked/stopped, that is, information of the destination, such as the position, name, etc.

In such manner, the target position setting unit 64 uses this related information to more efficiently select the best target position for parking/stopping the vehicle 2 near the destination designated by the user.

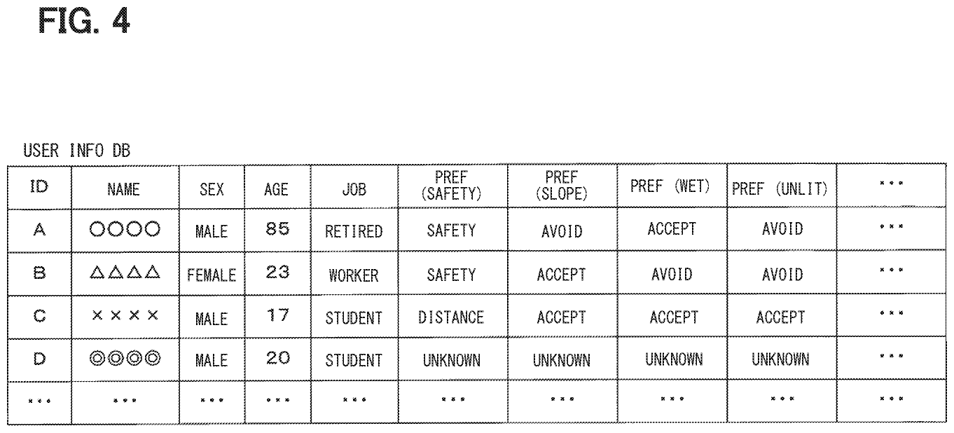

Next, as shown in FIG. 4, the user information DB 58 is provided as a storage medium registering (i.e., storing) information specific to a user (i.e., to each of the users) identified by user ID, such as user attribute information including user name, and user preference information of the user regarding preference of the target position.

The information representing the user attribute includes the user's sex, age, occupation, and the like. In addition, the information indicating the user preference is used to set a target position preferred by the user when searching the target position DB 56 for a target position near the destination and setting a reached target position as a position where the vehicle 2 is actually parked or stopped.

Therefore, the information indicating the user preference includes information on the safety and ease of walking on the road when the user walks from the target position to the destination. Specifically, it includes information about safety such as whether the user prioritizes safety or distance, and information about ease of walking such as whether to accept or avoid a slope. Also included is information about the environmental conditions preferred by the user, such as whether the user may avoid getting wet in the rain, whether to accept or avoid unlit, dark roads.

Although not shown in FIG. 4, in the user information DB 58, as information unique to the user, information regarding the vehicle type and size of the vehicle 2 owned or used by the user and information whether the user is a driver or not can also be registered.

As the storage medium provided as the target position DB 56 and the user information DB 58, a storage medium having a large storage capacity and capable of easily registering and updating data is used, such as HDD, SSD or the like.

Next, the control unit 60 is composed of a computer including a CPU, a ROM, a RAM, and the like. Then, the control unit 60 has functions as a target position extraction unit 62, a target position setting unit 64, a target situation collection unit 66, a target position determination unit 68, a target position accumulation unit 70, a user identification unit 72, a user information collection unit 74 and a user information accumulation unit 76.

That is, in the control unit 60, each of these functions is realized by the CPU executing control processing shown on the right side of FIG. 5 according to the program stored in the ROM or the storage unit 54.

Here, the target position extraction unit 62 is a function that searches the target position DB 56 based on the destination transmitted from the information terminal 10 of the vehicle 2 and the information of the user who designates the destination, and extracts a position or positions near the destination where the vehicle 2 can be parked or stopped.

Further, the target position setting unit 64 is a function that selects a target position most suitable for the user to park or stop the vehicle 2 from the target positions extracted by the target position extraction unit 62, and transmits the selected target position to the information terminal 10 via the communication unit 52.

Therefore, in the present embodiment, the target position extraction unit 62 and the target position setting unit 64 on the server 50 side and the target position setting unit 34 on the information terminal 10 side correspond to a target position recommendation unit of the present disclosure.

Next, the target situation collection unit 66 is a function that obtains via the communication unit 52 the target situation of the vehicle 2 transmitted from the information terminal 10 of the vehicle 2 when the vehicle 2 is actually parked or stopped, that is, the position of the vehicle 2 and the surrounding road condition, and stores them in the storage unit 54.

In addition, the target position determination unit 68 is a function that determines whether the position where the vehicle 2 is actually parked or stopped is worth/suitable for registration to the target position DB 56, based on the target situation obtained by the target situation collection unit 66.

The target position accumulation unit 70 is a function that registers to the target position DB 56 a target position determined by the target position determination unit 68 as suitable for registration in the target position DB 56.

Note that the target position accumulation unit 70 generates information indicating the type of the target position and information of whether parking is possible at such position as well as various road information based on the target situation obtained from the information terminal 10 and stored in the storage unit 54, and stores the generated information as one target position data along with the position information in the target position DB 56.

However, the target position accumulation unit 70 may be configured to store, in addition to the information obtained from the information terminal 10, information on the target positions collected or purchased from other servers, e.g., information on traffic restrictions associated with construction, etc., in the target position DB 56.

Next, the user information collection unit 74 is a function that obtains the user information transmitted from the user information collection unit 40 of the information terminal 10 via the communication unit 52 and stores it in the storage unit 54. Note that the user information collection unit 74 may obtain the user information not only as the user information transmitted from the information terminal 10 but also as login information of the information terminal 10 registered on the server 50 side, from other web pages, and the like.

The user identification unit 72 is a function that identifies a user and recognizes whether the user is a driver or occupant mere passenger, just like the user identification unit 38 of the information terminal 10. That is, the user identification unit 72 identifies the user from the login information of the information terminal 10, from the user information collected by the user information collection unit 74, from the user information registered in the user information DB 58, or the like, for a determination of whether or not the user is the driver.

Further, the user information accumulation unit 76 is a function that recognizes the attributes and preferences of the user identified by the user identification unit 38 from the user information collected by the user information collection unit 74 and stored in the storage unit 54, and updates the user information DB based on a recognition result.

### Control Processing

Next, a control process performed by the control unit 30 of the information terminal 10 and the control unit 60 of the server 50 to implement each of the above functions is described.

In the present embodiment, the information terminal 10 transmits login information such as a user ID and a password to the server 50, and the server 50 recognizes the information terminal 10 from the login information and sends a reply to the information terminal 10, thereby enabling communication with the server 50.

As shown in FIG. 5, in the information terminal 10, first, in S110, a login operation input process is performed in which the user operates the UI unit 20 to input login information. Then, in such login operation input process, when the login information is input, the login information is transmitted to the server 50 via the communication unit 12.

On the other hand, on the server 50 side, when the communication unit 52 receives the login information transmitted from the information terminal 10, in S510, a login operation reception process of receiving the login operation of the user based on the login information is performed.

In such login operation reception process, it is determined from the login information received by the communication unit 52 whether or not the user who performed the login operation is registered in the user information DB 58, and if the user is registered therein, the login operation is received and accepted, and the process proceeds to S520.

Then, in S520, information indicating a successful login is transmitted from the communication unit 52 to the information terminal 10 that has transmitted the login information, and in the subsequent S530, a reception process is performed, in which the information such as a destination and the like transmitted from the information terminal 10 is received by the server 50 via the communication unit 52.

Therefore, on the information terminal 10 side, after sending the login information in S110, the information terminal 10 waits for the information indicating the successful login from the server 50 in S120, and upon receiving the successful login information, the information terminal 10 determines that the login is complete, and the process proceeds to S130.

Note that, in the present embodiment, the user is identified on the information terminal 10 side and the server 50 side in the processes of S110, S120, S510, and S520, these steps function respectively as user identification units 38, 72.

Next, in the information terminal 10, in S130, the process as a destination input unit 32 that receives a destination input from the user by the operation of the UI unit 20 is performed. Note that a destination received in S130 is a general or broad destination such as a store or facility of user's need to which a user (may also be referred to as a specific user hereinafter) is guided, that is, the information representing the destination store or facility by name, address, telephone number, and the like.

Then, in subsequent S140, it is determined whether or not the vehicle 2 needs to be parked near the destination received in S130, or whether merely stopping is sufficient. This process is performed for determining whether the vehicle 2 needs to be parked (e.g., at least for a while) when the vehicle 2 has traveled and arrived at the destination received in S130 (such as an adult going to a grocery store), or whether the vehicle 2 needs to be just temporarily stopped at or around the destination (a child being dropped off at a school).

In the determination process of S140, the user information obtained from the login information or the user information input by the operation of the UI unit 20 is used. Based on the user information, it is determined whether or not the target user is the driver of the vehicle 2.

Then, if the user is a driver, it is determined that the vehicle 2 needs to be parked near the destination, and if the user is not a driver, it is determined that the vehicle 2 needs to be stopped there only temporarily for the user to get off from the vehicle 2.

Next, in S150, the communication unit 12 causes the server 50 to transmit the information indicating the destination and the necessity of parking obtained in the processes of S130 and S140. Then, on the server 50 side, the information indicating the destination (i.e., destination information, hereinafter) and the necessity of parking (i.e., parking need information, hereinafter) transmitted from the information terminal 10 is obtained in the reception process of S530, and the process proceeds to S540.

Note that, in S150, when transmitting the destination from the information terminal 10 to the server 50, the information of the destination obtained in S130 may be transmitted as it is, or position information calculable/derivable from the information of the destination and the map data may be transmitted.

Then, when the information terminal 10 transmits the destination in S150, the process (on the terminal 10 side) proceeds to S160, and performs a reception process of obtaining the information indicating the target position of the vehicle 2 transmitted from the server 50.

Note that, in S530, if the information indicating the necessity of parking (i.e., parking need information) is not obtainable from the information terminal 10, the parking need information indicating the necessity of parking registered in advance for the target user is obtained from the user information DB 58.

Next, in S540, detail information of the target user is obtained by searching the user information DB 58. Further, in S540, the vehicle information of the vehicle owned or used by the specific user (hereinafter, specific vehicle) is also obtained from the user information DB 58.

Note that, when it is not possible to obtain the parking need information indicating the necessity of parking from the user information DB 58 in S530, or when the vehicle information cannot be obtained from the user information DB 58 in S540, a request may be sent to the information terminal 10 to provide such information, for prompting the target user to input information.

Next, in S550, a process as the target position extraction unit 62 is performed, for extracting target position candidates where the vehicle 2 can be parked or stopped near the destination, by searching the target position DB 56 based on the information indicating the destination and the necessity of parking obtained in S530.

That is, in S550, it is determined from the parking necessity information whether or not the vehicle 2 needs to be parked, and if the vehicle 2 needs to be parked, the process extracts parkable positions, i.e., the target position where the vehicle 2 is parkable near the destination, from the target position DB 56. Further, if the vehicle 2 does not need to be parked, in addition to the target positions near the destination where the vehicle 2 can be parked, the target positions near the destination where the vehicle can only be stopped are also extracted. In other words, the vehicle 2 may be stopped in parking positions and also be stopped in stopping (only) positions. Optionally, parking positions requiring fees to park may be excluded as targets for merely stopping, because most users do not want to pay parking fees for merely stopping.

Then, in subsequent S560, based on the detail information of the target user and the vehicle information obtained in S540, from among the target position candidates extracted in S550, the target position that best matches the attributes and preferences of the target user is selected and transmitted to the information terminal 10.

Then, on the information terminal 10 side, in the reception process of S160, the selected target position is obtained, and in subsequent S170, the target position obtained in S160 is set as the target destination of the vehicle 2.

Note that the process of S560 performed on the server 50 side and the process of S160 performed on the information terminal 10 side are processes for realizing the functions of the target position setting units 64, 34 shown in FIG. 2.

Here, since the target position DB 56 has the road information such as traffic volume and road width registered therein for roads around the target position, when a destination of the vehicle 2 is selected from among the plurality of target position candidates in S560, selection can be made in the following manner.

For example, if the vehicle on which the specific user is boarding/riding is a large vehicle, it may be preferable (i.e., selection of the target position may be configurable) not to select a target position where the width of the surrounding road is narrow, and/or not to select a target position ahead of (i.e., reachable only after passing through) a narrow width road. Also, if the target position is “on the road” (e.g., a parking space along a sidewalk), map data is used to determine whether the target position has a railing dividing the road and the sidewalk, and if the target position has the railing, selection of such position as the destination may be avoided, since the railing may prevent or may make it difficult for the user from smoothly getting off from the vehicle 2, especially if the user is handicapped. Also, during a time zone in which the road near the target position has a high volume of traffic (i.e., heavy traffic) or a high volume of pedestrian, selection of such target position may be avoided.

Also, since the user information DB 58 has the information indicating the attributes and preferences of the user registered therein, when selecting a target position as a destination of the vehicle 2 from among a plurality of target position candidates in S560, selection can be made in the following manner.

For example, when the target user is a woman or an elderly person, selection of a target position may be made for avoiding a walk through a dark or unlit place. Also, if the preference of the target user is specified as avoidance of getting wet with rain, a target position that allows the user to reach the final destination without getting wet may preferentially be selected depending on the weather, i.e., on a rainy day, and if the user preference is specified as acceptance of getting the wet, a target position closer to the final destination may be preferentially selected.

Further, if the preference of the target user prioritizes safety, selection of a target position may be made to pick up a position from which the final destination is reachable via a path having traffic signal, pedestrian crossing and the like. On the other hand, if the preference of the target user prioritizes distance to the final destination, selection of a target position may be made to pick up a position from which the final destination is reachable via a path having no traffic signal, pedestrian crossing or the like.

Further, when the preference of the target user is specified to avoid a slope, selection of a target position may be made to pick up a position from which the final destination is reachable via a path without slope or stairs. On the other hand, when the preference of the target user is specified as accepting a slope, selection of a target position may be made to pick up a position from which the final destination is reachable via a path including a slope or a stair.

Note that, in the present embodiment, it is described that selection of a position is made on the server 50 side, to select a target position that matches the attribute and preference of the target user from among a plurality of target position candidates where the vehicle 2 is parkable/stoppable near the destination. However, such selection may also be performable on the information terminal 10 side.

That is, the server 50 may transmit in S560 the plurality of target position candidates extracted in S550 to the information terminal 10, and the information terminal 10 may select in S170 a target position suitable for the target user from among the plurality of target position candidates.

However, in such case, the server 50 needs to transmit to the information terminal 10 in S560 both of (i) the plurality of target position candidates and the user information registered in the user information DB 58, for a selection of a target position that matches the attributes and preferences (factors) of the target user on the information terminal 10 side.

As described above, when the target position that matches the attributes and preferences of the target user is selected on the server 50 side and the selected target position is set as the destination of the vehicle 2 on the information terminal 10 side, the information terminal 10 side, the travel guidance process of S180 is performed.

The travel guidance process is a process of performing travel guidance of the vehicle 2 to the target position set as the destination via the travel guide unit 18, and the process is repeated until it is determined in S190 that the vehicle 2 is parked or stopped.

Whether the vehicle 2 is parked or (temporarily, only for a short time, for example) stopped is determined based on, for example, the vehicle state such as the state of the parking brake, the shift position of the transmission, the vehicle stop time (i.e., duration), the unlocking of the door, the opening closing of the door, or the like. Alternatively, it may also be determined based on the situation around the vehicle.

When it is determined in S190 that the vehicle 2 is parked or stopped, the process proceeds to S200, and thereafter, the vehicle position and the vehicle state obtained via the sensor unit 22, as well as the situation around the vehicle including an image are collected for at least a predetermined period required for the occupant to get off from the vehicle 2.

The process of S200 is a process of realizing the functions of the target situation collection unit 36 and the user information collection unit 40, and the process transmits the collected information to the server 50 via the communication unit 12. Next, in S210, after the vehicle 2 is parked or stopped, an evaluation input process is performed to receive an evaluation regarding the target position, which is the current vehicle position, from the target user.

That is, in S210, it is determined whether the target position, which is the current vehicle position, is suitable for parking or stopping the vehicle 2. In other words, the user is prompted to input an evaluation of whether the current vehicle position should be registered to the target position DB 56 as a (suitable) target position.

Then, subsequently in S220, the evaluation result is transmitted to the server 50 via the communication unit 12, and the control process on the information terminal 10 side is ended. Next, in the server 50, after transmitting the target position to the information terminal 10 in S560, the process proceeds to S570, and the processing as the target situation collection unit 66 is performed. That is, in S570, various types of information such as the vehicle position, the vehicle state, and the situation around the vehicle transmitted from the information terminal 10 in the process of S200 are obtained and stored in the storage unit 54.

Further, subsequently in S580, the evaluation result of the target position transmitted from the information terminal 10 in the process of S220 is obtained. Then, in S590, based on the information on the target position obtained in S570 and the evaluation result obtained in S580, it is determined whether the target position obtained in S570 is registrable/acceptable to the target position DB 56.

The process of S590 is a process of realizing the function of the target position determination unit 68. For example, when a low evaluation result has been obtained, it is determined that the vehicle position obtained as the target position in S570 is not a suitable position to be registered to the target position DB 56, that is, registration of such a position to the DB 56 is declined.

Further, in S590, the road width at a position around the parked/stopped vehicle 2 is detected from the situation around the parked vehicle 2 or from the map data, and if the road width is narrow and it is not suitable as a target position, registration of such a position is declined.

Further, in S590, the traffic volume of the vehicle and/or the pedestrian volume are recognized from the situation around the parked/stopped vehicle 2, and if the traffic volume and/or the pedestrian volume are high and it is not suitable as a target position, registration of such a position to the DB 56 is declined.

Further, in S590, it is determined from the map data or the traffic regulation information obtained from the external server whether or not the vehicle position obtained in S570 is a no target position, registration of such a position to the DB 56 is declined.

Note that, in S590, it may further be determined, based on the map data, whether the vehicle position obtained in S570 is a position on the road, a position in a parking space, or a position in a private property. When the vehicle position is determined as a position in a private property, registration of such a position may be declined.

Further, in S590, the vehicle position obtained in S570 may also be determined from the history of the past target positions stored in the storage unit 54 as to whether the vehicle position has been rarely used as a target position, and when the vehicle position has been rarely used as the target position, registration of such a position to the DB 56 may be declined.

In such case, the past target position(s) in the past for the determination of whether or not such a position or positions have been actually used for target may be the vehicle position obtained in S570 with a margin of error of few decimeters to several meters therearound.

Next, in S590, when it is determined that the vehicle position obtained in S570 is registrable as a target position, the process proceeds to S600, and if it is determined that the vehicle position is not registrable as a target position, the process proceeds to S610.

In S600, the vehicle position obtained in S570 is registered to the target position DB 56 as a target position, and the process as the target position accumulation unit 70 is performed, and the process proceeds to S610. That is, in S600, based on the information indicating the vehicle state and the condition around the vehicle obtained in S570 and/or the information obtained from the map data and the like, the information regarding the target position other than the position information is generated, and the position information is then added to such information to generate target position data including the position information for the registration to the target position DB 56.

For example, in FIG. 3, the type information indicating whether the target position is on the road or in the parking space is determined based on the position of the target position and the map data, and the type information determined thereby is registered to the target position DB 56. Further, in FIG. 3, the identification information indicating whether the target position allows parking of the vehicle or allows stopping only is determined based on whether (i) the door of the drivers seat is opened or (ii) only the door(s) other than the drivers seat is/are opened when the vehicle 2 is parked or stopped, and the identification information determined thereby is registered to the target position DB 56.

That is, for example, (A) when only the door that is not the driver's seat is opened, it is determined that the vehicle 2 is stopped, and (B) when the door of the driver's seat is opened, it is determined whether the vehicle 2 is parked or stopped based further on (i) a duration of time of the vehicle's stopping at such position and (ii) the door opening/closing timing.

In addition, regarding the information about the traffic volume, the pedestrian volume, the number of parked vehicles on/along the street, and the like shown in FIG. 3, such information is recognized based on the time or time zone of the target of the vehicle 2 as well as the surrounding image captured by the camera, for the registration to the target position DB 56.

Further, the road information such as the width of the road, the turnability (i.e., U-TURN) and the like shown in FIG. 3 is recognized based on the road information obtained from the map data, the image of the road taken by the camera, and the like, for the registration to the target position DB 56.

Furthermore, in S600, based on the information obtained in S570 and the like, not only the target position is newly registered to the target position DB 56, but also the already-registered target position data may be corrected.

For example, when a target position located within a predetermined error range is already registered with respect to the vehicle position obtained in S570, the position information of the already-registered target position is corrected to match the vehicle position obtained in S570, for diminishing the shift therefrom.

Further, when (i) the same target position as the vehicle position obtained in S570 is registered to the target position DB 56, and (ii) there is a discrepancy between (a) the registered target position data and (b) the current condition of the surrounding currently obtained, the registered information in the DB 56 is corrected to match the current condition of the target position.

In S600, as described above, as the related information of the target position, information indicating the time when the vehicle 2 is parked/stopped, the original destination initially set by the target user, and the like may be stored in the target position DB 56.

Next, in S610, the attribute or preference of the target user is recognized based on the login information and/or a behavior history of the target user obtained from the information obtained in S570, and the recognized attribute/preference is registered to the user information DB 58, which is performed as processing of the user information accumulation unit 76. Then, after the processing of S610 is performed, the control process is ended.

In S610, information about attributes such as the name, sex, age, and occupation of the target user is obtained as (i) the user information input by the target user operating the UI unit 20, (ii) the user information stored in the storage unit 54 in association with the login information, or the like.

As for the information about the preference of the target user, correction/update of such information is performed based on (i) the behavior history of the target user after the vehicle 2 is parked or stopped, (ii) the evaluation result of the target position by the target user, or the like in addition to (iii) the information input by the target user via the UI unit 20. Note that the behavior history of the target user after target the vehicle 2 can be determined from the image around the vehicle obtained in S570.

That is, in S610, for example, when the target user gets off from the vehicle 2 at a target position on a slope, it can be determined that the target user accepts the slope. Further, for example, when the target user gets off from the vehicle 2 at a target position on a wet road, it can be determined that the target user accepts the wet road. Further, for example, when the target user gets off from the vehicle 2 at a target position on a dark road, it can be determined that the user accepts the dark road.

Further, in S610, the user preference regarding safety can be determined based on, for example, the positional relationship between the place where the vehicle 2 is parked or stopped and the destination, which indicates whether the user prioritizes distance or safety. Further, even when the target user gets off from the vehicle 2 at a certain target position, if the evaluation of such target position is low, it can be determined that such target position does not match the preference of the target user.

Then, in S610, if the determination result for the user preference is different from the information in the user information DB 58, or if the preference of the target user is not registered to the user information DB 58, the user information DB 58 is updated according to the determination result of the current time.

### Advantageous Effects 1

As described above, in a target position guidance system 1 of the present embodiment, the server 50 includes the target position DB 56 and the user information DB 58.

When the destination is transmitted from the information terminal 10 on the vehicle 2 to the server 50, the server 50 determines whether or not the target user who has designated a destination needs to park the vehicle 2, and extracts a plurality of target positions where the vehicle 2 can be parked or stopped near the destination.

Further, the server 50 selects a target position that matches the attribute and preference of the target user registered to the user information DB 58, from among the plurality of extracted target positions, and recommends it to the information terminal 10.

Therefore, on the information terminal 10 side, as described below, the most suitable target position for the target user can be guided as the destination of the travel of the vehicle 2.

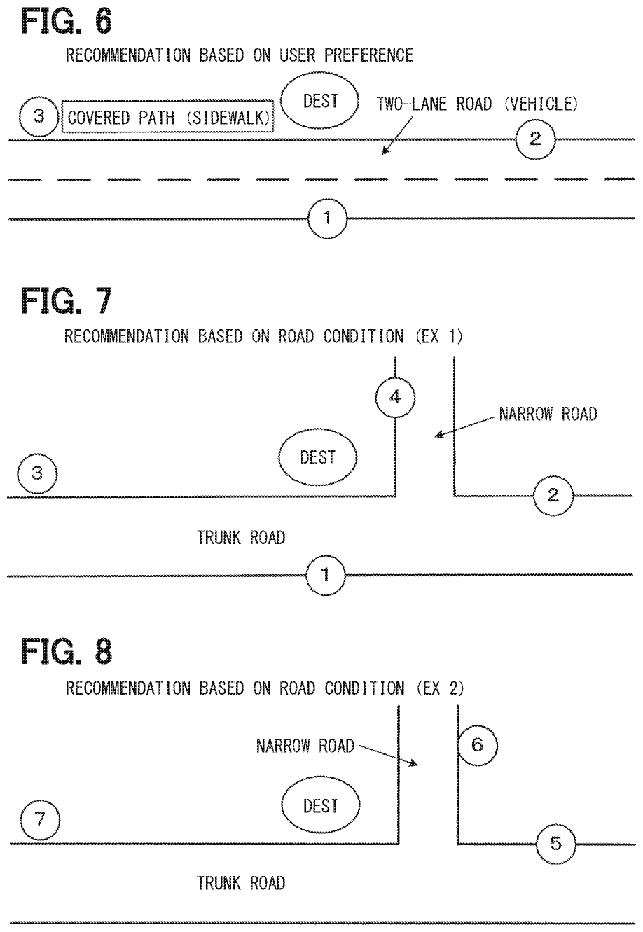

### Recommendation Based on User Preference, FIG. 6

For example, when users A, B, are C shown in FIG. 4 are chauffeured to the same destination under the same conditions, the server 50 has the following information input thereto as the conditions of such drive: destination: coordinates, necessity of parking: unnecessary, vehicle type: standard vehicle, weather: rain, expected arrival date: March 3rd (Sunday), expected arrival time: 18:00 and the like.

In such case, the server 50 searches the target position DB 56 based on the position information of the destination and the parking need information (i.e., information on the necessity of parking), and extracts plural target positions where the vehicle 2 can be stopped near the destination. FIG. 6 shows target positions candidates. the extracted target position candidates are respectively shown as entry No. 1 to No. 3 in FIG. 3, whose positional relationships between the target position and the destination both obtained from the map data are shown in FIG. 6. In such case, for the respective users A, B, C, the destination of the vehicle 2 is set as follows.

In other words, all of the above-described three target position candidates satisfy the conditions of drive (i.e., drop-off or pick-up), thereby a recommended target position is selected from the candidates based on the user preference. If the target user is the user A, since the preference is to prioritize safety over distance, although the distance is longer than the target position No. 1, the target position No. 2 is selected, for No. 2 position needs not cross the street.

Note that, No. 3 position is also usable for parking the vehicle 2. However, since no parking is required for the current drive, and No. 3 position is farther than No. 2 position, No. 3 position will not be selected as the recommended target position for the user A.

In addition, when the target user is the user B, since the preference of the user B is to avoid getting wet, No. 3 position is selected as recommendation where there is a covered path (i.e., a sidewalk with a roof) to the destination. Further, when the target user is the user C, since the preference of the user C is to prioritize distance, No. 1 position is selected as the shortest distance to the destination.

### Recommendation Based on Road Conditions: Example 1, FIG. 7

Next, when the user D shown in FIG. 4 is driven to the destination of FIG. 7, by a standard vehicle on a weekday, at the expected arrival time of 12:30, the target position candidates of No. 1 to No. 4 are selected from the target position DB 56 as shown in FIG. 3. Further, it is assumed that the positional relationship between the target position candidates and the destination is as shown in FIG. 7.

In such case, although the information indicating the attribute of the user D is registered to the user information DB 58, no information indicating the preference of the user D is registered thereto, which leads to a determination that all of the target position candidates No. 1 to No. 4 are suitable for the preference of the user D.

However, the target position DB 56 has registered thereto various kinds of road information such as the traffic volume of the surrounding roads, the volume of the pedestrian, the number of parked vehicles on/along the street (i.e., MANY or FEW), and the road width, for each of the target positions. Therefore, on the server 50 side, based on the road information described above, a target position suitable for stopping the vehicle 2 can be selected from the four target position candidates that match the preference of the user D.

That is, among the four target position candidates, No. 4 position candidate and No. 2 position candidate are not selected, because the traffic volume or the pedestrian volume is heavy (i.e., the number of cars or pedestrians is large) at the expected arrival time which makes it dangerous even for stopping. In addition, No. 1 target position candidate has many on-street parked vehicles on the surrounding roads, which makes it more difficult to stop the vehicle 2 as compared with the target position candidate No. 3. That is, No. 1 position is not selected.

On the other hand, at the target position candidate No. 3, the vehicle 2 can be parked and stopped, and No. 3 position candidate has no problem in the surrounding road condition, and thus is selected as the recommended target position.

### Recommendation Based on Road Conditions: Example 2, FIG. 8

When the target user drives a large-sized vehicle at an expected arrival time of 7:00 on a weekday to go to a destination, it is assumed that the target positions of No. 5, 6, and 7 in FIG. 3 are selected. Further, the positional relationship between the target position candidates and the destination is shown in FIG. 8, with each of the target position candidates considered as satisfying the preference of the specific user.

In this case, since the specific user is a driver, it is necessary to park the large-sized vehicle driven by the specific user at the target position. Therefore, in such case, since the target position candidate No. 5 allows only stopping, it is not selected, and the target position candidate No. 6 is not selected because a large-sized vehicle cannot be parked there.

On the other hand, the target position candidate No. 7 is selected as a recommended target position because a large-sized vehicle can be parked there and having no problem with the surrounding roads. As described above, according to the target position guidance system 1 of the present embodiment, when the vehicle 2 is parked/stopped near the destination designated by the target user, a most suitable target position can be selected and recommended according to the attributes and preferences of the target user or according to the road condition of the target position.

### Advantageous Effects 2

On the other hand, in the target position guidance system 1 of the present embodiment, when the vehicle 2 is actually parked or stopped near the destination, the information terminal 10 transmits the position information, the vehicle state, and the surrounding situation to the server 50. Then, on the server 50 side, based on these information, the target state of the vehicle 2 at the target position and the road condition around the target position are registered to the target position DB 56 together with the position information.

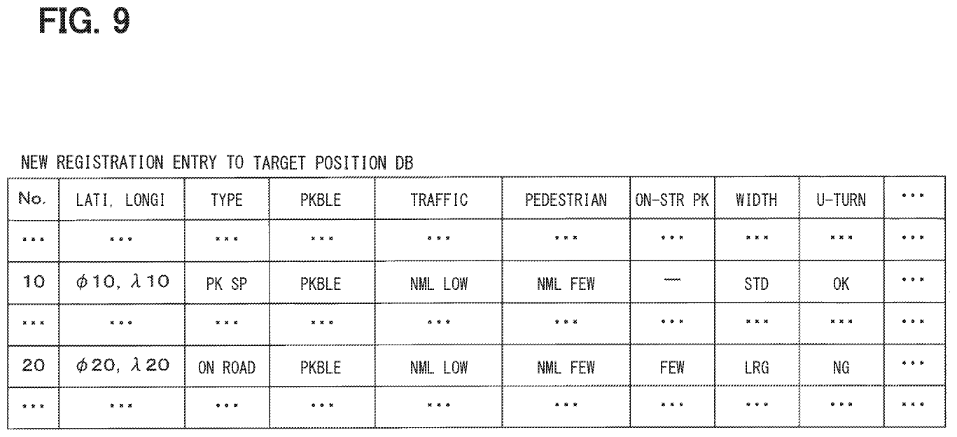

For example, it is assumed that information is obtained from the sensor unit 22 of the information terminal 10, such as, the position information of the vehicle 2: φ10, λ10 (latitude, longitude), the stop time (duration): 2 hours and 20 minutes, the doors opened at: the driver's seat and the passenger's seat, the traffic volume: low, the pedestrian volume: low, road width: standard vehicle only, U-turn: OK and the like (See FIG. 9). Further, it is determined that the target position is a parking space (e.g., car park near the airport) based on the position information and the map data or the surrounding images.

In this case, since the doors of the driver's seat and the passenger's seat are opened, and the stop time is as long as 2 hours or more, the position of the vehicle 2 is determined as “parkable,” thereby such position is newly registered to the target position DB 56, as No. 10 entry of FIG. 9.

Further, for another example, it is assumed that information is obtained from the sensor unit 22 of the information terminal 10, such as the position information of the vehicle 2: φ20, λ20 (latitude, longitude), the stop time (duration): 40 minutes, the door opened at: the drivers seat, the traffic volume: law, the pedestrian volume: low, the on-street parked vehicles: few, road width: allows standard/passenger vehicle only, U-turn: NG, and the like (See FIG. 9). Further, it is assumed that the target position is determined as a position “on the road/on-street” and the target position is not in a parking prohibited area (i.e., NO “no parking any time” sign).

In such case, since the door of the drivers seat is opened at the target position, the traffic volume of the vehicle and the pedestrian volume are both low, and the parking of a vehicle is not prohibited there, thus, such target position of the vehicle 2 is determined as a dedicated parking space on-street/roadside where a vehicle is parkable, and such target position is newly registered to the target position DB 56, together with the information described above, as No. 20 entry of FIG. 9.

Further, for example, it is assumed that information of the vehicle 2 is obtained from the sensor unit 22 of the information terminal 10, such as the position information: ϕ5′, λ5′ (latitude, longitude), the stop time: 8:10 to 8:13 (A.M.) on a weekday, the door opened at: the passenger seat, the traffic volume (on surrounding road(s)): low, on-street parking: only a few vehicles, road width: allows large vehicles, U-turn: NG (i.e., not possible). In addition, it is determined that the target position is determined as a position on the street, from the position information and the map data or the captured surrounding image(s).

In this case: the passenger seat door is opened at the target position, the stop time is as short as 3 minutes, the traffic volume and the pedestrian volume around the vehicle 2 are low, and the number of parked vehicles on the street is just a few. Therefore, the target position of the vehicle 2 is determined as a stop-only position. The vehicle position is within a preset range of error/tolerance from the position of No. 5 entry in FIG. 3, with the other information different from No. 5 entry only by traffic volume (i.e., No. 5 entry traffic volume: heavy on weekdays v. this position traffic volume: low). Therefore, in this case, the target position DB 56 is updated by rewriting the traffic volume information at the target position No. 5 so as to correspond to/consistent with the information obtained this time.

As described above, the target position guidance system 1 according to the present embodiment has a function of target position database generation device in one aspect of the present disclosure, thus generating the target position data and registering the data to the target position DB 56 as well as updating the registered target position data.

On the server 50 side, when the target position transmitted from the information terminal 10 indicates (i) prohibition of target of the vehicle 2 due to traffic regulations or (ii) low user evaluation of the position, registration of such data to the target position DB 56 will not be performed.

Therefore, the target position DB 56 is “sequentially” updated to an optimal database for guiding the user to the parking/stop position(s), and the reliability of the target position DB 56 is improved simultaneously. Further, in the target position guidance system 1 of the present embodiment, the server 50 has the user information DB 58 in which the attributes and preferences of each of the users are stored is provided therein so that each of the users is guided to the target position(s) suitably, i.e., according to their attributes/preferences.

Furthermore, on the server 50 side, the user information DB 58 is updated based on the information transmitted from the information terminal 10 when the vehicle 2 is actually parked, in terms of (i) grasping the behavior history of the user after target the vehicle 2, (ii) recognizing the user preference from the grasped behavior history, and (iii) updating the DB 58 accordingly.

For example, change (i.e., update) of the user D preference may happen when (i) the user D in FIG. 4 gets off from the vehicle 2 at No. 1 position in FIG. 6 where he needs to cross a high traffic volume road even though No. 1 position is close to the destination and (ii) the user D gives a high evaluation to such position. That is, the user D preference may change from “(prioritize) safety” to “(prioritize) distance.”

Therefore, according to the present embodiment, even in case that the user information stored in the user information DB 58 is insufficient, or even in case that the stored user information is incorrect, the user information DB 58 can be updated to appropriately/correctly reflect the user preference, user to user.

Therefore, the user information DB 58 is updatable, user to user, to appropriately/correctly reflect the user preference “sequentially or on demand (on factual basis),” which enables user-specific, most appropriate guidance to the target position, suitably provide for each of the users.

As described above, an embodiment of the present disclosure has been disclosed. However, the present disclosure is not limited to such embodiment, i.e., may further be implementable with various modifications.

### Modification 1

For example, in the above-described embodiment, when a target user and a target vehicle are identified by the server 50, the target user and the target vehicle are identifiable by searching the user information DB 58 based on a login information for obtaining the user information of the target user.

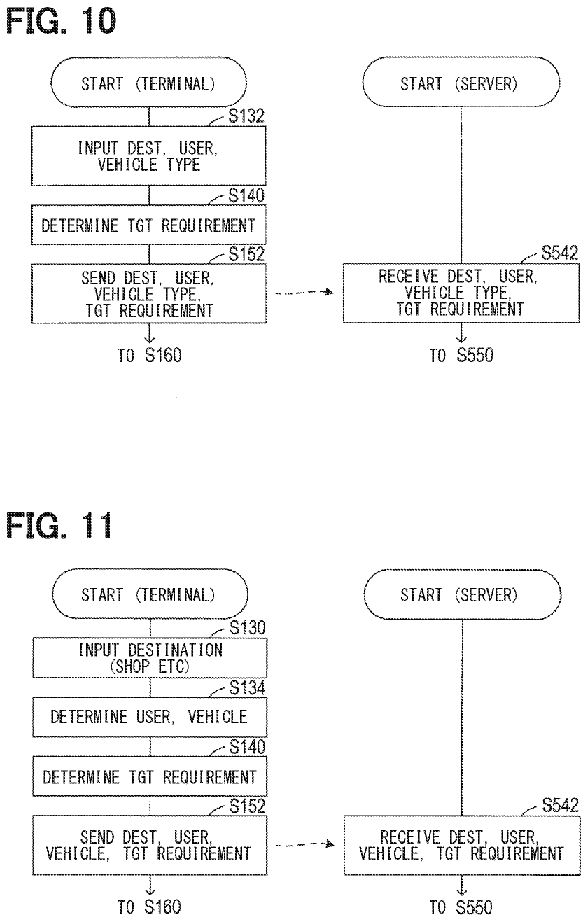

On the other hand, as shown in FIG. 10, in the control process performed on the information terminal 10, user and/or vehicle identification may be achievable by firstly receiving an input of the information of the destination, the target user and the target vehicle in S132, which are input by the user.

That is, after receiving the information of the destination, the target user, and the target vehicle in S132, it is determined in S140 whether or not parking of the vehicle is required, and then these pieces of information are transmitted to the server 50 in S152, before transitioning to S160.

In such manner, on the server 50 side, at the beginning of the control process, i.e., in S542, the above information transmitted from the information terminal 10 is received, and the process proceeds to S550. That is, a recommended target position is suitably provided to the target user, just like the above-described embodiment.

Further, as shown in FIG. 11, in the control process performed on the information terminal 10, user or vehicle identification may be achievable by firstly receiving a destination (e.g., shopping mall, etc.) input from a user, and then, in S134, the target user or vehicle may be identified based on the input from the sensor unit 22.

After identifying the target user and the target vehicle in S134, the necessity of parking the vehicle is determined in S140, and then, subsequently in S152, these pieces of information are transmitted to the server 50, and the process proceeds to S160.

Even in such manner, on the server 50 side, the above information transmitted from the information terminal 10 is receivable at the beginning of the control process, i.e., in S542, and thereafter the process proceeds to S550, which also enables a recommendation of a suitable target position to the target user.

Note that, in the flowcharts shown in FIGS. 5, 10, and 11, the processing of S140 on the information terminal 10 side needs not always be performed. That is, the necessity of parking the vehicle may be determined on the server 50 side, by obtaining information indicating whether the target user is a driver from the user information DB 58.

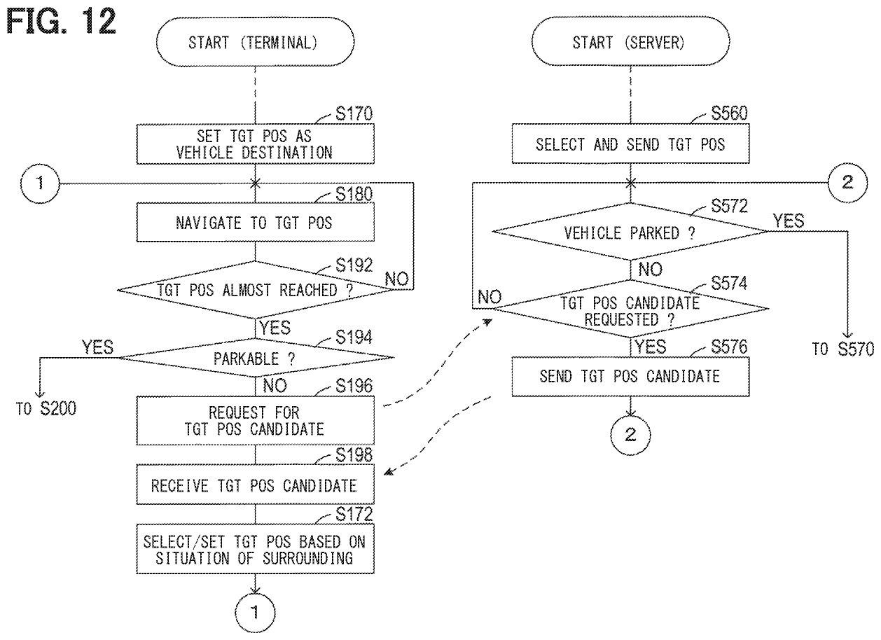

### Modification 2, FIG. 12

In the above-described embodiment, the information terminal 10 provides travel guidance to a recommended target position, which is recommended by the server 50, and, when the vehicle 2 is parked or stopped at such position, the travel guidance is ended and information related to the actual target position is transmitted to the server 50.

However, in a situation that the vehicle 2 cannot be parked at the target position recommended by the server 50, (a search of) a different target position candidate other than the target position recommended by the server 50 may be requested from the information terminal 10 (to the server 50). The (newly found) target position may then be set on the information terminal 10 side (and provided for the user).

In FIG. 12, on the information terminal 10 side, the target position recommended by the server 50 is set as the destination of the vehicle 2 in S170, and after the travel guidance is started in S180, the process proceeds to S192.

Then, in S192, it is determined whether or not the vehicle 2 has reached the vicinity of the target position, thereby (repeating and) waiting for the vehicle 2 to reach the vicinity of the target position, and when the vehicle 2 reaches the vicinity of the target position, it is determined in S194 whether the vehicle 2 can be parked or stopped.

If it is determined in S194 that the vehicle 2 can be parked/stopped, the vehicle 2 is parked in such vicinity of the target position, and the process proceeds to S200 shown in FIG. 5. If it is determined that the vehicle 2 cannot be parked/stopped at such vicinity, the process proceeds to S196 to send request (from the terminal 10) to the server 50 for a “new/different” target position candidate or candidates.

Further, after sending a request for the target position candidate, the server 50 in response transmits the target position candidate(s) other than the previously-recommended target position. Therefore, in S198, the target position candidate is received by the terminal 10, and the process proceeds to S172.

Then, in S172, a target position suitable for target the vehicle 2 is selected from among the target position candidates received in S198 in consideration of the situation around the target position, and the selected destination of the vehicle 2 is newly-set as a new destination, and the process (on the terminal 10 side) proceeds to S180.

Note that the parkability/stoppability determination process in S194 and the target position selection process in S172 may be performed based on an operation input from the user by the operation of the UI unit 20, or may be automatically performed by the control unit 30 based on a predetermined determination/selection condition/criterion.

On the other hand, on the server 50 side, in S560, when a target position selected from among the plural target position candidates is transmitted to the information terminal 10, subsequently in S572, it is determined whether or not the vehicle 2 is parked/stopped. It should be noted that such a determination may also be made by determining whether or not the information on the target position has already been transmitted from the information terminal 10.

Then, when it is determined that the vehicle 2 is parked or stopped, the process proceeds to S570 in FIG. 5, and when it is determined that the vehicle 2 cannot be parked or stopped, the process proceeds to S574, and it is then determined whether the information terminal 10 has requested for a target position candidate.

In S574, if it is determined that no request for target position candidates has been received from the information terminal 10, the process returns to S572. If it is determined that a request for target position candidates has been received from the information terminal 10, the process proceeds to S576. Then, in S576, the target position candidates other than the previously-recommended target position are transmitted to the information terminal 10, and the process returns to 5572.

Note that, in S576, the target position candidates (already) extracted in S550 of FIG. 5 may be transmitted to the information terminal 10, OR the search range may be expanded from the previous search and the target position candidates may be searched in the same procedure as the one in S550, for re-extracting new candidates, and such candidates may then be transmitted to the information terminal 10.

In such manner, even when the vehicle 2 cannot be parked at a target position recommended by the server 50, the user can still select a target position from among the new target position candidates, which improves the usability of the system.

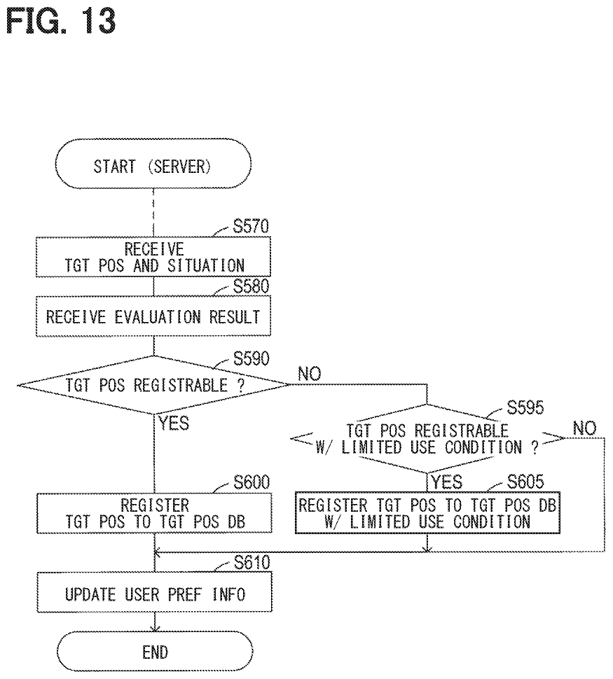

### Modification 3, FIG. 13

In the above-described embodiment, when it is determined in S590 that the vehicle position obtained in S570 is not registrable as a target position (to a database), the process proceeds to S610 without registering such vehicle position to the target position DB 56 in S600.

On the other hand, when it is determined in S590 that the vehicle position is not registrable as a target position, it may then be determined in S595 whether the vehicle position obtained in S570 is registrable as a target position with a limited use condition.

Then, if it is determined in S595 that the vehicle position described above is usable as a target position by limiting the use condition, the process proceeds to S605, and the vehicle position with the limited use condition is registered to the target position DB 56, and the process proceeds to S610.

Note that if it is still determined in S595 that the obtained vehicle position cannot be used as a target position even if the use condition is limited, the process proceeds to S610. In such manner, for example, when it is determined in S590 that the vehicle position cannot be registered based on the evaluation result and/or the condition of the surrounding, no-use condition of such position (e.g., information such as date, day of the week, time zone and the like may be picked up as prohibiting the use of the relevant vehicle position as a target position) is still registered as a use condition to the target position DB 56.

Further, for example, even when it is determined in S590 that width of the surrounding roads of a certain vehicle position is narrow and the certain vehicle position is determined as not suitable for registration as a target position, a use condition specifying the size of the parkable/stoppable vehicle of such vehicle position may be limited according to the width of such surrounding roads, and such vehicle position may become registrable to the target position DB 56.

### Other Modifications

In the above-described embodiment(s), the target position DB 56 stores target position data including the position information, the type information, the identification information, the road information, and the like for each of the target positions where the vehicle 2 is parkable or stoppable.

On the other hand, when only the position information of the target positions may be registered to the target position DB 56 as the target position data, the target position guidance system of the present disclosure can still be realized.

That is, even if the target position DB 56 is composed only of the position information of the target positions, the target positions near the destination are still extractable from such database. Further, when multiple target positions are extracted therefrom, the user can select one or more positions from among the multiple target positions by obtaining the type of the respective target positions and/or the condition of the surrounding road(s) from the map information of the navigation device or the external server, as the one suitably matching to the user attributes or preferences.

In the above-described embodiment(s), the target position data is generated in S600 for a registration to the target position DB 56 or for an update thereof, based on the vehicle state and surrounding conditions obtained from the vehicle 2 that is actually parked/stopped, the information obtained from the map data, and the like.

On the other hand, in S600, with respect to the target position registered to or updated in the target position DB 56, information indicating what kind of user has used such position, such as the preference of the target user who has highly evaluated such target position, may (further) be stored in the target position DB 56.

Further, in the above embodiment(s), the target position guidance system 1 has been described as including the server 50 and the information terminal 10 on the vehicle 2. On the other hand, such system may be configured as having a copy of the target position DB 56 in the information terminal 10, for enabling the information terminal 10 alone to serve as the target position guidance system 1.

Note that, in such case, the server 50 may serve as a target position database generation device that collects information on the target position(s) of the vehicle 2 from each of the information terminals 10 for the generation of the target position DB 56, and the copy of the target position DB 56 after update may be delivered/distributed to each of the information terminals 10.

Further, the function of the information terminal 10 may be realized as, for example, a navigation device installed on the vehicle 2 and a mobile terminal (such as a cell phone) carried by the user. That is, the information terminal 10 may be composed of plural information terminals/devices.

In addition, multiple functions of one component/in the above embodiment(s) may also be realized by multiple components/, or a function of one component may be realized by multiple components/.

In addition, multiple functions of multiple components may be realized by one component, or a single function realized by multiple components may be realized by one component. In addition, a part of the configuration of the above embodiment(s) may be omitted. In addition, at least a part of the configuration of the above embodiment(s) may be added to or substituted for the configuration of the other embodiment(s) described above.

Further, the target position guidance system or the database generation device of the present disclosure may be realized by a program for causing a computer to function as the target position guidance system or the database generation device. Further, the present disclosure can be implemented in various forms such as a non-transitory, substantive recording medium such as a semiconductor memory in which a relevant program is recorded, a target position guidance method and a database generation method, and the like.

What is claimed is:

1. A target position guidance system comprising:
a target position database in which position information indicating respective target positions where a vehicle can be parked or stopped is stored;
a destination input unit configured to input a destination chosen by a user;
a user identification unit configured to identify the user; and
a target position recommendation unit configured to recommend a recommended target position that matches at least one factor of the identified user from among position candidates extracted from the target position database based on the chosen destination, wherein a factor is an attribute or a preference.

2. The target position guidance system according to claim 1, wherein
the target position database additionally has identification information indicating whether each target position allows parking of the vehicle or only allows stopping of the vehicle;
the user identification unit is configured to identify the user and determine a necessity of parking of the vehicle for the identified user, and
the target position recommendation unit is configured to (i) extract target positions based on a determination result of the necessity of parking by the user identifying unit, and (ii) recommend the extracted target position that best matches the user.

3. The target position guidance system according to claim 1 further comprising:
a user information database storing information indicating at least one factor for each registered user, wherein
the target position recommendation unit is configured to (i) detect a factor of the identified user, and (ii) select the target position that matches the factor of the identified user.

4. The target position guidance system according to claim 1, wherein
the target position database stores the position information indicating the position of each of the target positions together with road information indicating road conditions around the target position, and
the target position recommendation unit is configured to select the target position that matches the factor of the user from among the target positions extracted from the target position database, based on the road information.

5. The target position guidance system according to claim 4, wherein
the target position recommendation unit is configured to select the target position that matches the factor of the user based on the road information and environmental conditions including time or weather when the vehicle is parked or stopped from among the target positions extracted from the target position database.

6. The target position guidance system of claim 4, wherein
the road information in the target position database includes information about a road width around the target position, and
the target position recommendation unit selects, from among the target positions extracted from the target position database, the position that has (i) matching road width and size of the vehicle to be parked/stopped and (ii) the factor of the identified user.

7. A database generation device for generating a target position database in which a target position where a vehicle can be parked or stopped is stored, the device comprising:
a target situation collection unit configured to collect a vehicle position from a parked or stopped vehicle;
a target position determination unit configured to determine whether the vehicle position is suitable for parking or stopping based on vehicle positions collected by the target situation collection unit and at least one determination condition; and
a target position storage unit configured to (i) generate target position data including the vehicle position collected by the target situation collection unit as the target position and (ii) store the target position data in the target position database when the target position determination unit determines that the vehicle position is suitable as the target position of the vehicle.

8. The database generating device according to claim 7, wherein
when the vehicle position is not suitable as the target position of the vehicle, the target position determination unit is configured to determine whether the vehicle position is usable as the target position of a vehicle with a limited use condition, and
the target position accumulation unit is configured to (i) generate the target position data including the limited use condition as the position information of the target position when the target position determination unit determines that the vehicle position is usable as the parking/stopping position of the vehicle with the limited use conditions and (ii) accumulate the target position data in the target position database.

9. The database generation device according to claim 7, wherein
the target situation collection unit is configured to collect, from the parked or stopped vehicle, a vehicle state or a surrounding road condition in addition to the vehicle position,
the target position determination unit is configured to determine whether the vehicle position is suitable as the target position of the vehicle, based on the information collected by the target situation collection unit and a determination condition, and
the target position accumulation unit is configured to (i) generate target position data including (a) the position information of the target position and (b) the target identification information or the road information of the surrounding road, and (ii) accumulate the data in the target position database.

10. The database generation device according to claim 7, wherein
the target position determination unit is configured to use traffic regulation information of the road around the vehicle position as one of the determination conditions.

11. The database generation device according to claim 7, wherein
the target position determination unit is configured to use, as one of the determination conditions, the road width or a traffic volume obtained from the surrounding road condition.

12. The database generation device according to claim 7, wherein
in addition to the vehicle position, the target situation collection unit is configured to obtain an evaluation of a target position by the user of the parked or stopped vehicle, and
the target position determination unit is configured to determine that the vehicle position is not suitable as the target position when the evaluation of the target position obtained by the target situation collection unit is low.

13. The database generation device according to claim 7, further comprising:
a user information collection unit for collecting information indicating preference factor of a user who gets off from a vehicle when the vehicle is parked or stopped; and
a user information collection unit for accumulating, as the user information, information indicating the factor of the user collected by the user information collection unit in a user information database.

14. The database generating device according to claim 13, wherein
the user information collection unit is configured to collect a behavior history of the user after the vehicle is parked or stopped, and
the user information accumulation unit is configured to (i) recognize the user preference from the behavior history of the user collected by the user information collection unit and (ii) accumulate the user preference in the user information database.

15. A terminal for a vehicle, the terminal comprising:
a processor;
a non-transitory computer-readable storage medium including instructions that, when executed, cause the terminal to:
perform a login operation input process in which a user inputs login information, and transmit the login information to a server;
receive a first transmission from the server indicating that the user is registered in a user information database;
receive a destination from the user;
determine a target requirement, wherein the target requirement indicates whether the vehicle must be parked near the destination;
send the destination and the target requirement to the server;
receive a second transmission from the server indicating a target position for the vehicle;
set the target position as a vehicle destination;
guide the vehicle to the target position;
determine that the vehicle is parked or stopped;
collect information for a target situation collection unit of the server and for a user information unit of the server, and transmit the collected information to the server;
perform an evaluation input process to receive a user evaluation regarding the target position in which the vehicle is parked or stopped; and
transmit user evaluation information to the server.

16. The terminal of claim 15, wherein:
the destination from the user includes at least one of: a name, an address, a phone number, an email, and a website;
determining the target requirement is based at least partly upon whether the user is a driver or is a non-driver;
the second transmission includes at least two candidate target positions;
setting the target position as the vehicle destination includes selecting the target position from the candidate target positions;
collecting information for the target situation collection unit includes collecting: a state of the parking brake, a shift position of a transmission, a duration of a stopped condition, an unlocking of a door, an opening of the door, and an image of an area near the vehicle;
the user evaluation includes a determination of whether a present vehicle position is a suitable target position.
